(19) United States
(12) Patent Application Publication
(10) Pub. No.: US 2019/0026771 A1
(43) Pub. Date: Jan. 24, 2019

(54) INFORMATION PROCESSING APPARATUS, AND METHOD CARRIED OUT THEREBY

(71) Applicant: TOSHIBA TEC KABUSHIKI KAISHA, Tokyo (JP)

(72) Inventor: Takahiko YAMADA, Osaka Osaka (JP)

(21) Appl. No.: 16/041,390

(22) Filed: Jul. 20, 2018

(30) Foreign Application Priority Data
Jul. 21, 2017 (JP) 2017-142148

(51) Int. Cl. G06Q 30/02; G06K 7/14; G06Q 20/20

(52) U.S. Cl. CPC G06Q 30/0238; G06Q 20/208; G06Q 30/0283; G06K 7/1417

(57) ABSTRACT

In accordance with an embodiment, an information processing apparatus includes a code reader, a memory, and a processor. The processor is configured to control the code reader to read a code attached to a package, determine whether the read code indicates a predetermined code assigned to a package containing a plurality of commodities, and when the read code indicates the predetermined code, retrieve from the memory information about the package indicating a total number of the commodities contained in the package, retrieve from the memory information about each of the commodities indicating a unit price of each of the commodities, and calculate sales based on the total number of the commodities and the unit price of each of the commodities.

### CROSS-REFERENCE TO RELATED APPLICATION

This application is based upon and claims the benefit of priority from Japanese Patent Application No. 2017-142148, filed Jul. 21, 2017, the entire contents of which are incorporated herein by reference.

### FIELD

Embodiments described herein relate generally to an information processing apparatus, and method carried out thereby.

### BACKGROUND

At a grocery store, some commodities, such as alcoholic beverages and candies, are bundled and sold as a single package. For example, six bottles or two dozen of bottles of beer are bundled in advance and sold as a single package at the store.

To manage inventory and sales, the store usually assigns a unique code to such a package of the bundled commodities using a barcode or a two-dimensional code. Thus, it is common for the store to manage both the package of the bundled commodities and an individual commodity contained in the package with different codes, i.e., different commodities.

### DESCRIPTION OF THE DRAWINGS

FIG. 1 is a perspective view illustrating an appearance of a POS terminal as seen from a store clerk side according to an embodiment;

FIG. 2 is a block diagram illustrating a hardware configuration of the POS terminal;

FIG. 3 is a memory map illustrating a part of the configuration of a case master file;

FIG. 4 is a memory map illustrating a part of the configuration of a commodity master file;

FIG. 5 is a memory map illustrating a part of the configuration of promotion information;

FIG. 6 is a memory map illustrating a part of the configuration of sales management information;

FIG. 7 is a functional block diagram illustrating functional components of the POS terminal;

FIG. 8 is a flowchart for depicting the flow of a control process by the POS terminal;

FIG. 9 is a diagram illustrating an example of a receipt issued by the POS terminal;

FIG. 10 is a flowchart for depicting a flow of a return process by the POS terminal; and

FIG. 11 is a memory map illustrating a part of another configuration of the case master file.

### DETAILED DESCRIPTION

In accordance with an embodiment, an information processing apparatus includes a code reader, a memory, and a processor. The processor is configured to control the code reader to read a code attached to a package, determine whether the read code indicates a predetermined code assigned to a package containing a plurality of commodities, and when the read code indicates the predetermined code, retrieve from the memory information about the package indicating a total number of the commodities contained in the package, retrieve from the memory information about each of the commodities indicating a unit price of each of the commodities, and calculate sales based on the total number of the commodities and the unit price of each of the commodities.

Hereinafter, embodiments will be described in detail with reference to the accompanying drawings. In an embodiment, a cased commodity obtained by packaging or bundling a plurality of same commodities in one case is described as a packaged commodity. Each individual commodity packaged in the cased commodity is referred to as an individual commodity. The individual commodity may be sold as a single commodity. The individual commodity and the cased commodity are collectively referred to as a commodity. The present invention is not limited by the embodiments described below.

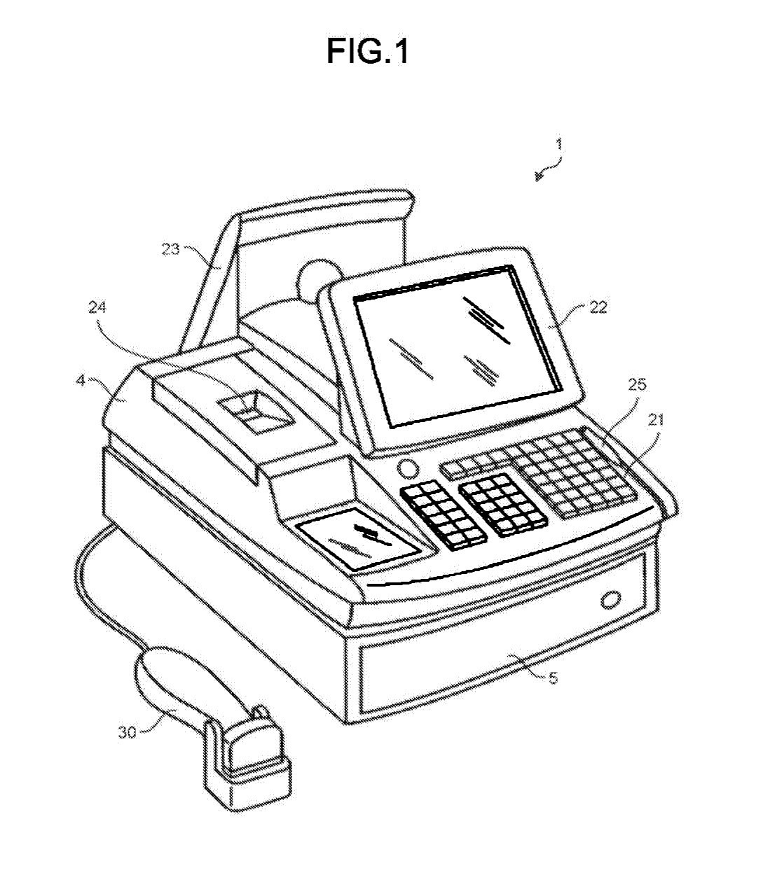

FIG. 1 is a perspective view illustrating a POS terminal 1 as viewed from a store clerk side according to an embodiment.

The POS terminal 1 executes a sales registration process and a checkout process of a commodity sold in a retail store. The sales registration process is a process of acquiring a commodity code by optically reading a symbol such as a barcode attached to a sold commodity in a transaction or from the captured symbol, displaying commodity information about the commodity (e.g., commodity name, price, etc.) read out using the acquired commodity code, and storing the commodity information in a random access memory (RAM), a storage device, or the like. The checkout process is a process of displaying a total amount relating to the transaction based on the commodity information stored in the RAM or the like in the sales registration process, displaying a change calculated based on a deposit received from a customer, and instructing a change dispensing machine to dispense the change. The commodity information and the checkout information (total amount, deposit amount, change amount, etc.) after the checkout process are printed on a receipt to be issued.

The POS terminal 1 has a main body 4 and a cash housing box 5. The cash housing box 5 has a drawer for housing cash, and stores cash such as bills and coins deposited by the customer, securities such as a gift certificate, change to be handed over to the customer, and the like.

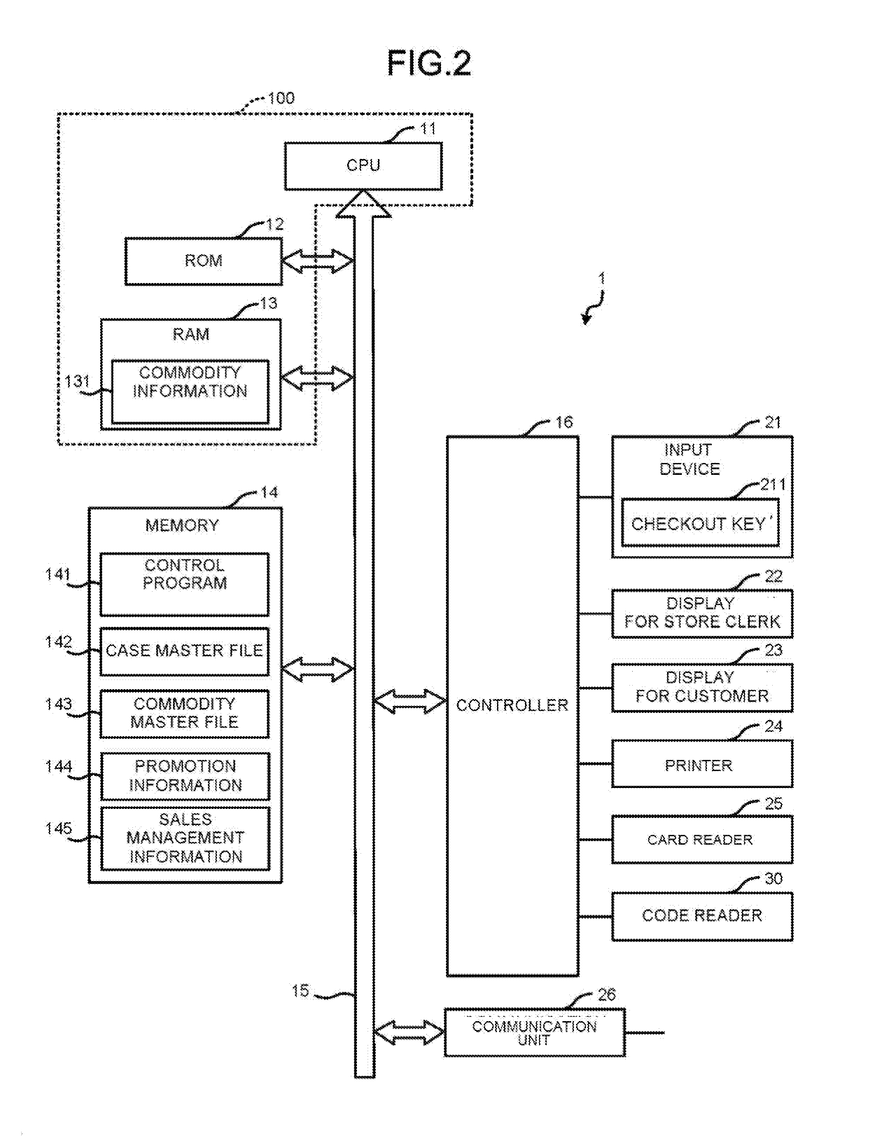

The main body 4 includes an input device 21, a display for store clerk 22, a display for customer 23, a printer 24, a card reader 25, and a code reader 30. The input device 21 is a keyboard provided with keys such as a numeric key for inputting numerals and a checkout key 211 for completing the sales registration (refer to FIG. 2). The display for store clerk 22 is a liquid crystal display or the like, and displays commodity information and checkout information for a store clerk who is an operator of the POS terminal 1. The display for customer 23 is a liquid crystal display or the like, and displays the commodity information and the checkout information for a customer.

The printer 24 is, for example, a thermal printer having a thermal transfer type printing head housed in the main body 4. The printer 24 issues a receipt by printing the commodity information and the checkout information accompanying the checkout process on a roll-shaped receipt paper.

The card reader 25 reads card information from a credit card or the like used for checkout which is presented by the customer. The code reader 30 is, for example, a handy type code reader. The code reader 30 optically reads symbols attached to the commodity and discount coupons using visible light, for example. The code reader 30 may read a symbol from a captured image.

The POS terminal 1 transmits the commodity information and the checkout information about the commodity on which the checkout process is carried out to a store server (not shown) via a communication unit 26 (refer to FIG. 2). The store server is communicably connected to one or more POS terminals 1 installed in the retail store. Each POS terminal 1 transmits sales information in a predetermined period (for example, one day) to the store server via the communication unit 26. The store server manages the sales information received from each POS terminal 1.

The hardware configuration of the POS terminal 1 is described below. FIG. 2 is a block diagram illustrating a hardware configuration of the POS terminal 1. As shown in FIG. 2, the POS terminal 1 includes a Central Processing Unit (CPU) 11, a Read Only Memory (ROM) 12, a Random Access Memory (RAM) 13, a memory 14, and the like. The CPU 11 is a processor for controlling the POS terminal 1. The ROM 12 stores various programs. The RAM 13 stores copied or decompressed programs and various data. The memory 14 stores various programs. The CPU 11, the ROM 12, the RAM 13, and the memory 14 are connected to each other via a bus 15. In an embodiment, the CPU 11, the ROM 12, and the RAM 13 are included in a control section 100. The CPU 11 executes a control program stored in the ROM 12 and the memory 14 and copied or decompressed in the RAM 13, and in this way, the control section 100 executes a control process described later relating to the POS terminal 1.

The RAM 13 stores commodity information 131 (e.g., commodity name, commodity price, etc.) and the number of commodities for the commodity which is subjected to the sales registration process based on the commodity code acquired from the information indicated by the symbol read by the code reader 30.

The memory 14 is a nonvolatile memory such as a Hard Disk Drive (HDD) or a flash memory that maintains information even when a power supply thereof is turned off. The memory 14 includes a control program 141, a case master file 142, a commodity master file 143, promotion information 144, and sales management information 145.

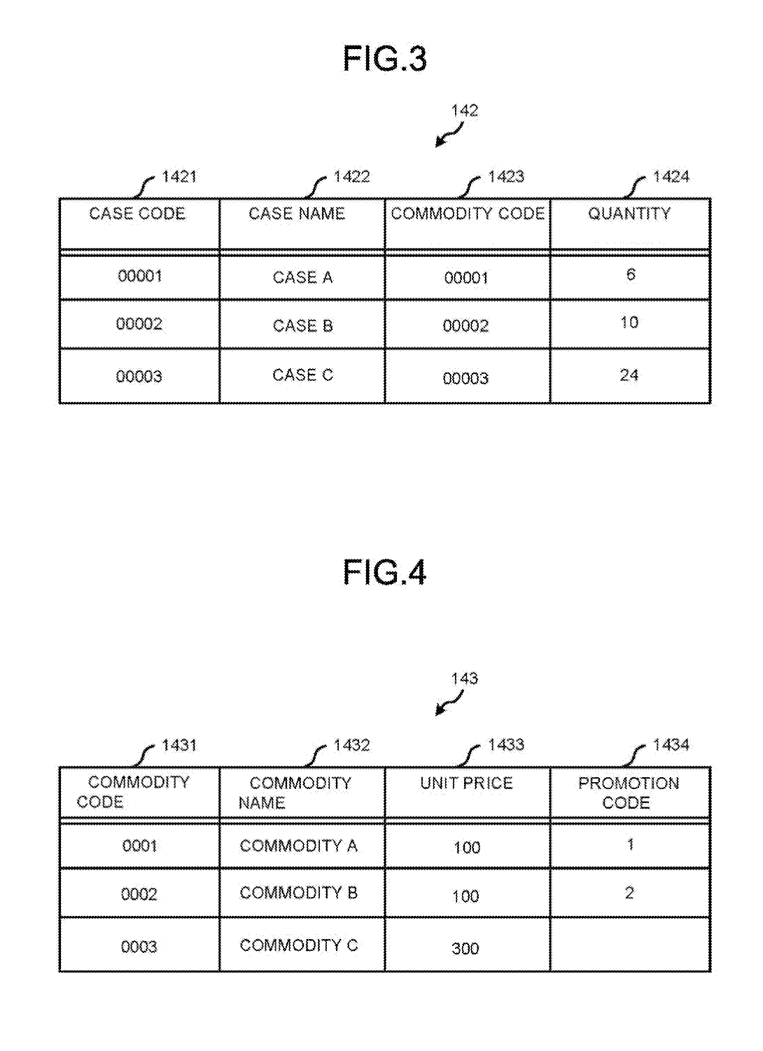

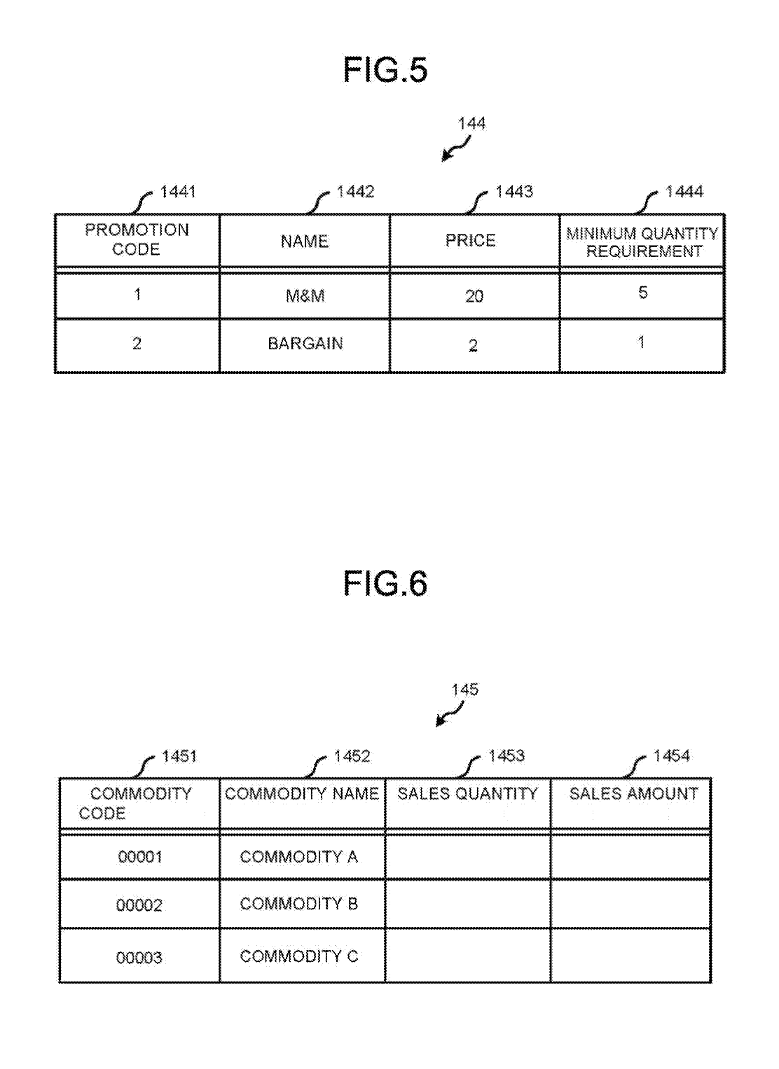

The control program 141 stores a control program for controlling the POS terminal 1. The case master file 142 stores information relating to the cased commodity for each cased commodity. The cased commodity refers to a commodity obtained by packaging a plurality of same commodities in advance as a pack or a commodity obtained by putting the plurality of same commodities in one case. Each individual commodity constituting the cased commodity is referred to as an individual commodity. Hereafter, the commodity packaged as a pack is described as an example. Details of the case master file 142 are described with reference to FIG. 3. The commodity master file 143 stores information relating to the individual commodities for each individual commodity (details are described with reference to FIG. 4). The promotion information 144 indicates promotion being executed in the retail store (details are described with reference to FIG. 5). The sales management information 145 indicates the sales of the individual commodities on which the POS terminal 1 carries out the checkout process (details are described with reference to FIG. 6).

The control section 100 is connected with the input device 21, the display for store clerk 22, the display for customer 23, the printer 24, the card reader 25, and the code reader 30 via the bus 15 and the controller 16. In response to an instruction from the control section 100, the controller 16 controls the input device 21, the display for store clerk 22, the display for customer 23, the printer 24, the card reader 25, and the code reader 30. In the following description, for the sake of explanation, it is assumed that the control section 100 performs control performed by the controller 16.

The input device 21 is a keyboard provided with keys such as a numeric key for inputting numerals and a checkout key 211 for declaring the termination of the sales registration. The display for store clerk 22 is a liquid crystal display or the like, and displays the commodity information, the checkout information, etc. to a store clerk who is an operator. The display for customer 23 is a liquid crystal display or the like, and displays the commodity information, the checkout information, etc. to the customer.

The printer 24 pulls out a roll-shaped receipt paper housed in the main body and prints the commodity information and the checkout information with a thermal printer having a thermal transfer type thermal head (not shown) to issue it as a receipt. The card reader 25 reads card information from a card such as a credit card presented by the customer. The code reader 30 is, for example, a handy type code reader. The code reader 30 optically reads codes attached to the commodity and discount coupons using visible light such as a laser. The code reader 30 may extract a code from an image captured by an image capturing section (not shown) and read it.

The control section 100 is connected to the communication unit 26 via the bus 15. The communication unit 26 is communicably connected with another POS terminal 1 installed in the retail store or the store server (not shown) connected with the POS terminal 1 via a communication line. The store server, which is a host device of the POS terminal 1, receives the commodity information and the checkout information from each POS terminal 1, and executes sales management of the commodity in the retail store.

Next, the case master file 142 is described. FIG. 3 is a memory map illustrating apart of the configuration of the case master file 142. As shown in FIG. 3, the case master file 142 stores information about a case code 1421, a case name 1422, a commodity code 1423, and a quantity 1424.

The case code 1421 is a code uniquely assigned to a cased commodity. In an embodiment, the case code has a distinctive coding format starting from numeral “45”, such as “45xxxxxx”, and the control section 100 can determine that the code read by the code reader 30 is a case code based on this distinctive coding format. In the following description, the case code is simplified to “0001” and described.

The case name 1422 indicates a name of the cased commodity specified by the case code. The commodity code 1423 indicates the commodity code of the individual commodity contained in the cased commodity specified by the case code. For example, if the cased commodity is “six-bottle packaged beer” in which six bottles of same beers are packaged in advance, a commodity code for specifying each of six bottles of beer (individual commodity) packaged is stored as the commodity code 1423. In this case, the case code is used to specify one packaged commodity, i.e., “six-bottle packaged beer”. The number of individual commodities contained in the cased commodity is stored as the quantity 1424. In the case of the aforementioned “six-bottle packaged beer”, “6” is stored as the quantity 1424.

Next, the commodity master file 143 is described. FIG. 4 is a memory map illustrating apart of the configuration of the commodity master file 143. As shown in FIG. 4, the commodity master file 143 stores information about a commodity code 1431, a commodity name 1432, a unit price 1433, and a promotion code 1434.

The commodity code 1431 is a code uniquely assigned to an individual commodity. In an embodiment, the commodity code has a distinctive code format starting from numeral “49”, such as “49xxxxxx”, and the control section 100 can determine that the code read by the code reader 30 indicates a commodity code based on this distinctive code format. In the following description, the commodity code is simplified to “00001” and described.

The commodity name 1432 indicates the commodity name of the individual commodity specified by the commodity code. The unit price 1433 stores a normal sales price (unit price) of one individual commodity specified by the commodity code. The promotion code 1434 is information about whether or not various promotions are applied to the individual commodity specified by the commodity code. In the example in FIG. 4, the numerals specified by the promotion code 1434 refers to a promotion to be applied. In the example in FIG. 4, a promotion with a promotion code “1” is applied to a commodity A. A promotion with a promotion code “2” is applied to a commodity B. Since no promotion code is stored for a commodity C, no promotion is applied to the commodity C.

Next, the promotion information 144 is described. FIG. 5 is a memory map illustrating apart of the configuration of the promotion information. As shown in FIG. 5, the promotion information 144 includes a promotion code 1441, a name 1442, a price 1443, and a minimum quantity requirement 1444. The promotion code 1441 is a promotion code for specifying the promotion. The name 1442 is a name of the promotion specified by the promotion code. The price 1443 is a price (for example, discount price) of the individual commodity adopted when the promotion specified by the promotion code is applied. The minimum quantity requirement 1444 indicates conditions under which the promotion is applied.

For example, in the case of the promotion with the promotion code “1”, a numerical value “5” is specified as the minimum quantity requirement 1444. In other words, if a customer purchases five individual commodities to which the same promotion is applied, the promotion with the promotion code “1” is applied. In FIG. 4, since the promotion code “1” is specified as the promotion code 1434 in association with the commodity A with the commodity code “00001”, when five or more commodities A are purchased, 20 yen is discounted from a total amount of five commodities A.

In the case of the promotion with the promotion code “2”, the numerical value “1” is specified as the minimum quantity requirement 1444. In other words, when one individual commodity is purchased, the promotion with the promotion code “2” is applied. In FIG. 4, since the promotion code “2” is specified as the promotion code 1434 in association with the commodity B with the commodity code “00002”, when one or more commodities B are purchased, 2 yen is discounted from a unit price of the commodity B.

Next, the sales management information 145 is described. FIG. 6 is a memory map illustrating apart of the configuration of the sales management information 145. As shown in FIG. 6, the sales management information 145 includes a commodity code 1451, a commodity name 1452, a sales quantity 1453, and a sales amount 1454.

The commodity code 1451 is a commodity code for specifying the individual commodity. The commodity name 1452 is the commodity name of the individual commodity specified by the commodity code. The sales quantity 1453 is a sales quantity of the individual commodity specified by the commodity code. The sales quantity refers to a cumulative number of the individual commodities on which the sales registration process is executed. In the case of the cased commodity, if the sales registration process is performed on the cased commodity, the number of the individual commodities packaged in the cased commodity is added as the number of the individual commodities. In the case of the aforementioned “six-bottle packaged beer”, the number “6” of the bottles of the beer as the individual commodity is added in association with the commodity code for identifying the beer.

The sales amount 1454 indicates a sales amount of the commodity subjected to the sales registration process. For example, if 10 commodities A are sold, since the unit price of the commodity A is 100 yen, 1000 yen (100 yen*10) is stored as the sales amount 1454. In a case in which the promotion shown in FIG. 5 is applied to the commodity A and the commodity A is discounted, the sales amount after subtracting a discount amount is stored as the sales amount 1454.

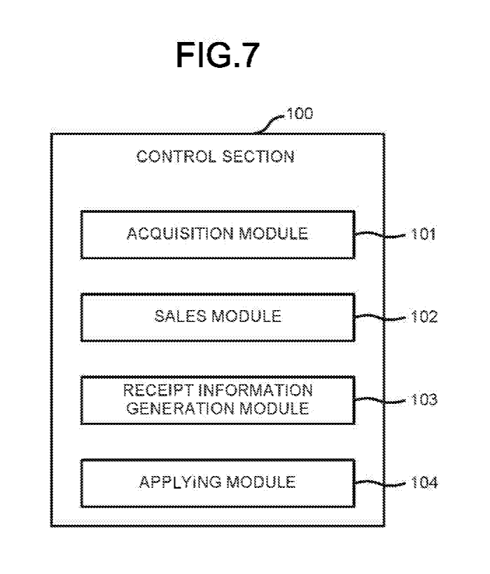

Below, the control by the POS terminal 1 is described in detail. FIG. 7 is a functional block diagram illustrating the functional components of the POS terminal 1. The control section 100 functions as an acquisition module 101, a sales module 102, a receipt information generation module 103, and an applying module 104 by executing the control program stored in the ROM 12 and the control program 141 in the memory 14.

If it is determined that the code read by the code reader is the case code for specifying the cased commodity consisting of plural individual commodities, the acquisition module 101 has a function of acquiring the commodity code of the individual commodity and the number of individual commodities packaged in the cased commodity.

The sales module 102 has a function of managing the sales of the cased commodity based on the acquired commodity code of the individual commodity and the acquired number thereof.

The receipt information generation module 103 has a function of generating receipt information relating to a transaction including the input cased commodity based on the commodity code of the individual commodity and the number thereof acquired by the acquisition module 101.

The applying module 104 has a function of applying the promotion to the individual commodity if the individual commodity specified by the commodity code of the individual commodity acquired based on the case code is the individual commodity to which the promotion is being applied.

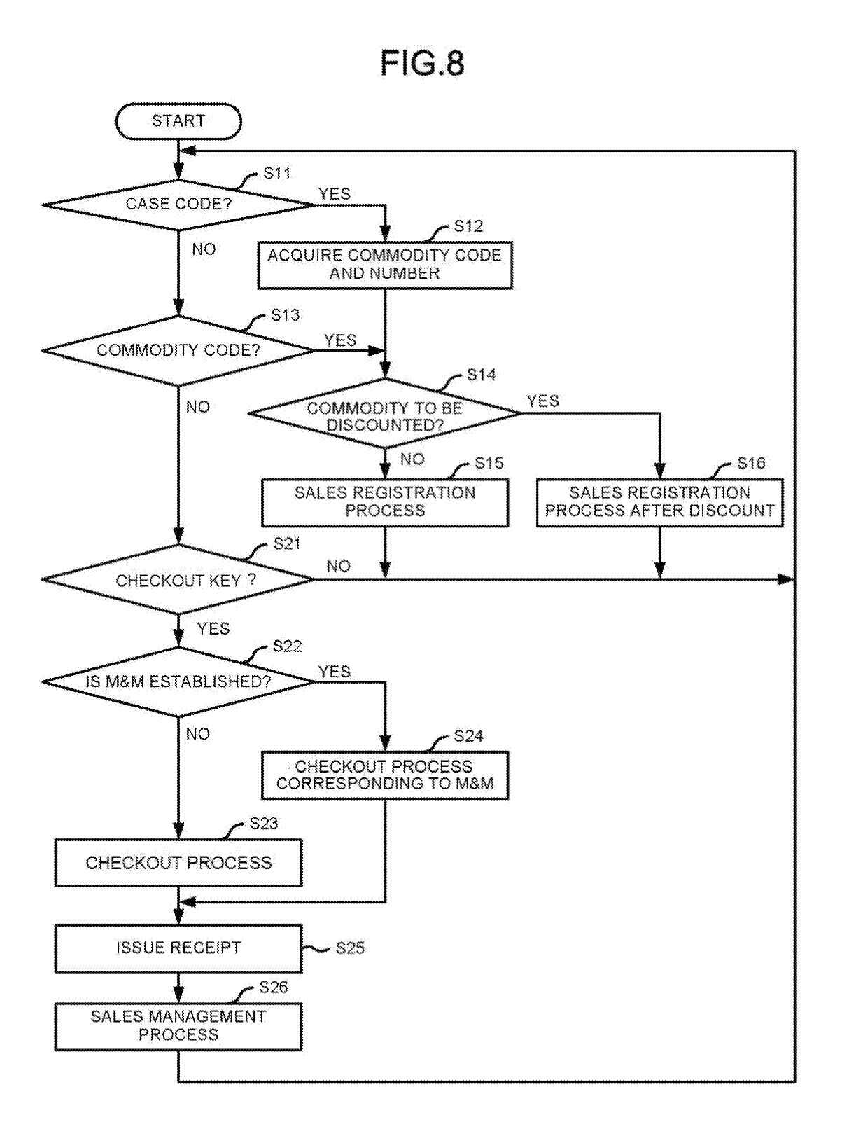

Next, the control process by the POS terminal 1 is described. FIG. 8 is a flowchart for depicting the flow of control processing of the POS terminal 1. As shown in FIG. 8, the control section 100 determines whether or not the code acquired based on the symbol read by the code reader 30 is a case code (Act S11). If it is determined that the code is the case code (Yes in Act S11), the control section 100 (acquisition module 101) searches the case master file 142 based on the acquired case code to acquire the commodity code of the individual commodity packaged in the cased commodity identified by the case code and the number thereof (Act S12). Next, the control section 100 searches the commodity master file 143 based on the acquired commodity code to determine whether or not the individual commodity specified by the commodity code is a commodity to be discounted (Act S14). The control section 100 determines that the individual commodity is the commodity to be discounted if the numeral “2” is stored as the promotion code 1434. The control section 100 determines that the individual commodity is not the commodity to be discounted if a numeral other than the numeral “2” is stored as the promotion code 1434 or no number is stored as the promotion code 1434.

If it is determined that the individual commodity is the commodity to be discounted (Yes in Act S14), the control section 100 (applying module 104) executes the sales registration process by discounting the amount stored as the price 1443 (Act S16). At this time, the control section 100 executes the sales registration process on the individual commodity specified by the commodity code acquired in Act S12 rather than on the cased commodity specified by the case code acquired in Act S11. If the case code of the cased commodity is acquired, the control section 100 executes the sales registration process repeatedly in accordance with the number of the individual commodities acquired in Act S12 based on the commodity code of the individual commodity, which is equivalent to a case of selling the individual commodities packaged in the cased commodity repeatedly in accordance with the number of packaged individual commodities. The control section 100 then returns to the process in Act S11.

On the other hand, if it is determined that the individual commodity is not the commodity to be discounted (No in Act S14), the control section 100 executes the sales registration processing using the amount stored as the unit price 1433 (Act S15). At this time, the control section 100 executes the sales registration process on the individual commodity specified by the commodity code acquired in Act S12 rather than on the cased commodity specified by the case code acquired in Act S11. If the case code of the cased commodity is acquired, the control section 100 executes the sales registration process repeatedly in accordance with the number of the individual commodities acquired in Act S12 based on the commodity code of the individual commodity, which is equivalent to a case of selling the individual commodities packaged in the cased commodity repeatedly in accordance with the number of packaged individual commodities. The control section 100 then returns to the process in Act S11.

For example, if the case code of “six-bottle packaged beer” described above is input, the control section 100 acquires the commodity code of beer and the numeral “6” in Act S12. In Act S15 or Act S16, the control section 100 executes the sales registration process repeatedly for six bottles of beer specified by the commodity code of the beer.

On the other hand, if it is determined that the case code is not acquired in Act S11 (No in Act S11), the control section 100 determines whether or not the commodity code of the individual commodity is acquired (Act S13). If it is determined that the commodity code of the individual commodity is acquired (Yes in Act S13), the control section 100 executes the processes subsequent to Act S14 in the same way as described above.

If it is determined that the commodity code of the individual commodity is not acquired (No in Act S13), the control section 100 determines whether or not the checkout key 211 is operated (Act S21). If it is determined that the checkout key 211 is operated (Yes in Act S21), the control section 100 determines whether or not a mix and match (M&M) is established for a specific commodity based on the commodity information about the commodity and the number thereof included in the commodity information 131 (Act S22).

M&M is a promotion for a discount or the like applicable when a predetermined number of same commodities are purchased at once. In an embodiment, the predetermined number is specified by the minimum quantity requirement 1444. In the example in FIG. 5, when five same commodities are purchased, M&M is established as the promotion with the promotion code “1”. For example, when six individual commodities to which the promotion with the promotion code “1” is being applied, M&M is applied to five of them, and the amount specified by the price 1443 is discounted from the total price which is five times the unit price specified by the unit price 1433. For the remaining one, the unit price specified by the unit price 1433 is applied.

If it is determined that M&M is established (Yes in Act S22), the control section 100 (applying module 104) executes the checkout process based on the amount obtained by subtracting the discount amount from the total amount of the individual commodities (Act S24). In other words, the control section 100 executes the checkout process in which the discount amount is subtracted based on the commodity code of the individual commodity and the number thereof acquired in Act S12. On the other hand, if it is determined that M&M is not established (No in Act S22), the control section 100 executes the checkout process based on the total amount of the individual commodities (Act S23). In other words, the control section 100 executes the checkout process without a discount based on the commodity code of the individual commodity and the number thereof acquired in Act S12.

Next, the control section 100 (receipt information generation module 103) issues a receipt on which the commodity information about the individual commodity and the number thereof included in the commodity information 131 and the checkout information are printed during the checkout process (Act S25). At this time, the control section 100 prints the commodity code for specifying the individual commodity subjected to the checkout process in Act S23 or Act S24, the commodity name and the unit price of the individual commodity, and the like. The control section 100 does not print the information about the cased commodity specified by the case code acquired in Act S11.

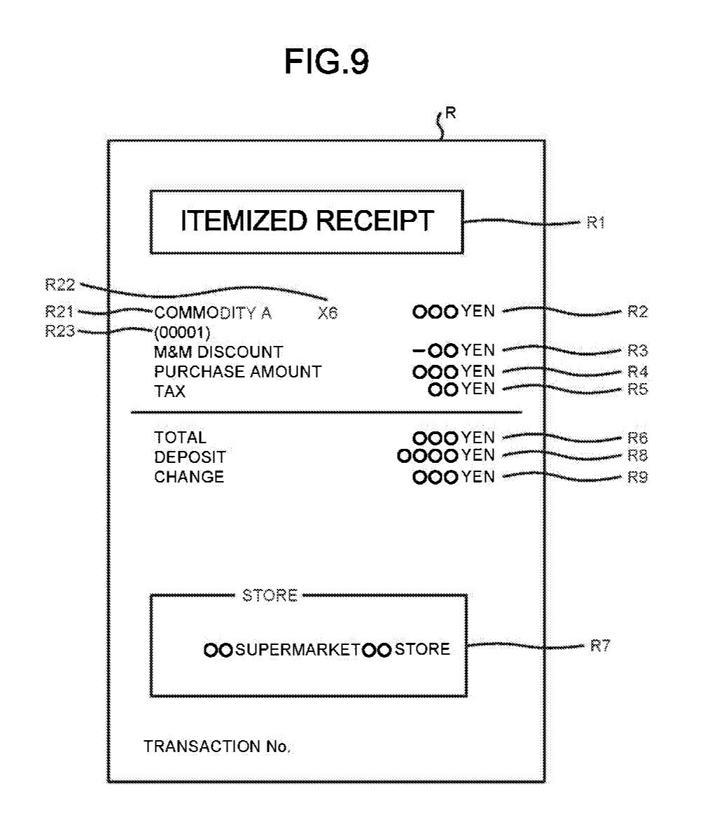

FIG. 9 shows an example of the receipt issued by the control section 100 through the process in Act S25. As shown in FIG. 9, on a receipt R, a character R1 of “itemized receipt” indicating the receipt is printed. On the receipt R, a commodity specification section R2 indicating the information about the individual commodity is printed. In the commodity detailed section R2, a commodity name R21 and a sales quantity R22 of the individual commodity are printed. In the example in FIG. 9, the commodity name of the commodity A which is the individual commodity is printed in the commodity name R21. A commodity code R23 for specifying the commodity is printed just under the commodity name R21. A numeral “6” indicating that six commodities A are sold is printed in the sales quantity R22. In the commodity specification section R2, the total amount when six commodities A are purchased is printed.

On the receipt R, a fact that M & M is established and the discount is made, a discount amount R3, a purchase amount R4 obtained by subtracting the discount amount from the total amount, a tax amount R5 levied with respect to the purchase amount, and a payment total amount R6 obtained by adding the purchase amount and the tax amount are printed. On the receipt R, a deposit money R8 received from the customer and a change R9 when there is the change are printed. A store R7 which issues the receipt R is printed on the receipt R.

When the cased commodity is purchased, in the commodity specification section R2 of the receipt R printed in this manner, the commodity name and the sales quantity of the individual commodity packaged in the cased commodity are also printed. The printing is the same as printing when several individual commodities are purchased rather than the cased commodity.

Returning again to the description in FIG. 8, next, the control section 100 (sales module 102) adds the number of the individual commodities subjected to the checkout process to the sales management information 145 and stores it (Act S26). In other words, when the individual commodity is sold, the control section 100 adds the commodity information about the individual commodity and the number thereof to the sales management information 145 and stores it. The control section 100 adds the number of the individual commodities packaged in the cased commodity and stores it even if the cased commodity is purchased. The control section 100 then returns to the process in Act S11. The control section 100 sends the cumulated sales quantity and sales amount of the individual commodities included in the sales management information 145 to the store server at a predetermined time.

In Act S21, if it is determined that the checkout key 211 is not operated (No in Act S21), the control section 100 returns to the process in Act S11.

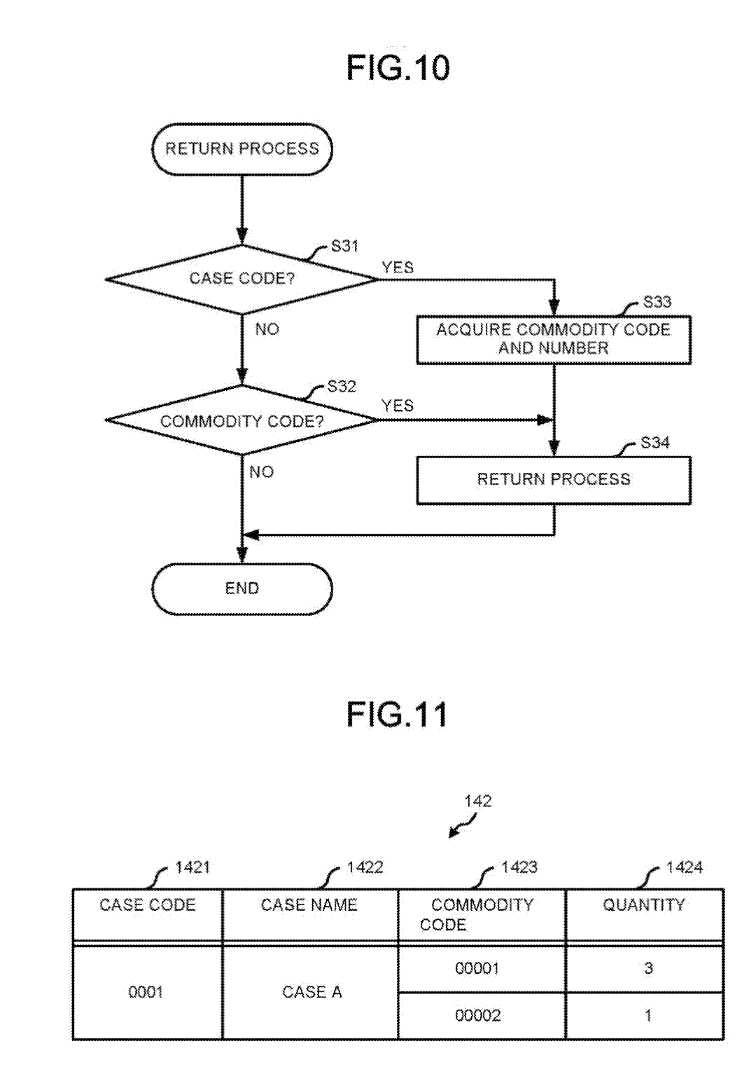

Next, a return process of the cased commodity is described. FIG. 10 is a flowchart for depicting the flow of the return process by the POS terminal 1. If there is a request for return of the purchased cased commodity from the customer, the store clerk who operates the POS terminal 1 operates a return key (not shown). If the return key is operated, the control section 100 executes a control based on the flowchart in FIG. 10. As shown in FIG. 10, the control section 100 determines whether or not the case code of the cased commodity to be returned in response to the operation on the return key is acquired (Act S31).

If it is determined that the case code is acquired (Yes in Act S31), the control section 100 searches the case master file 142 based on the acquired case code to acquire the commodity code of the individual commodity packaged in the cased commodity specified by the case code and the number thereof (Act S33). Then, the control section 100 executes the return process based on the acquired commodity code and number (Act S34). In this case, if the promotion (discount or M&M) is applied to the individual commodity, the return process is executed based on the correspondence with the promotion. For example, if a discount process is performed on the individual commodity, the discount amount is reduced and the return process is performed. The control section 100 then terminates the process. For the individual commodity on which the return process is executed, a value corresponding to the number of the individual commodities to be returned is deducted from the sales management information 145 and the total amount thereof is subtracted from the sales management information 145.

On the other hand, if it is determined in Act S31 that the case code is not acquired (No in Act S31), the control section 100 determines whether or not the commodity code of the individual commodity is acquired (Act S32). If it is determined that the commodity code of the individual commodity is acquired (Yes in Act S32), the control section 100 executes the process in Act S34. If it is determined that the commodity code of the individual commodity is not acquired (No in Act S32), the control section 100 ends the present process.

Below, a modification of the aforementioned embodiments is described. In the modification, for example, a case in which plural types of the individual commodities are packaged in one bag is shown. For example, plural types of confectionery are packaged in one bag. FIG. 11 is a memory map illustrating a part of the configuration of the case master file according to the modification. The case master file 142 in FIG. 11 is obtained by extracting the cased commodity with the case code “0001” in the case master file 142 in FIG. 3. The same configuration is also applicable for other cased commodities. As shown in FIG. 11, in the case master file 142, three commodities with the commodity code “00001” and one commodity with the commodity code “00002” are packaged as one cased commodity “case A”.

The control section 100 also performs control based on the flowchart in FIG. 8 in the modification. The control section 100 acquires the commodity codes of plural kinds of the individual commodity and the numbers thereof from the case code of the cased commodity in the process in Act S12. Then, the control section 100 executes the sales registration process subsequent to Act S14, determination on the establishment of M&M in Act S22, and the checkout process in Act S23 or Act S24 on the individual commodities specified by the acquired commodity codes.

According to such an embodiment, when the case code of the cased commodity is acquired, the commodity code for specifying the individual commodity packaged in the cased commodity specified by the case code and the number of the individual commodities are acquired, and the sales of the cased commodity as the individual commodity is managed. Therefore, it is possible to manage the cased commodity obtained by packaging plural individual commodities as the individual commodity.

According to an embodiment, when the cased commodity is sold, the receipt on which sales information about the individual commodity packaged as the cased commodity is printed is issued. Therefore, the customer can see the receipt and recognize the cased commodity and the individual commodity as the same commodity.

According to an embodiment, even when plural types of the individual commodity are packaged in the cased commodity, it is possible to manage respective individual commodities.

According to an embodiment, the promotion applied to the individual commodity may also be applicable to the cased commodity.

As described above, while certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in an embodiment, the case master file 142, the commodity master file 143, the promotion information 144, and the sales management information 145 are stored in the POS terminal 1. However, all or a part of the case master file 142, the commodity master file 143, the promotion information 144, and the sales management information 145 may be stored in the store server.

In an embodiment, the cased commodity placed in a case is described as an example of the packaged commodity. However, the packaged commodity may be a commodity which is not placed in the case. For example, the packaged commodity may be a commodity in which the individual commodities are bagged, or a commodity in which the individual commodities are bound by a belt or the like.

In an embodiment, as an example of the promotion, the discount of the unit price of the individual commodity and the discount when M&M is established are described. However, other promotions may be applied.

In an embodiment, the POS terminal 1 is described as the information processing apparatus. However, a store server may be used as the information processing apparatus.

The program executed by the POS terminal 1 of an embodiment may be recorded in a computer-readable recording medium such as a CD-ROM, a FD (Flexible Disk), a CD-R, a DVD (Digital Versatile Disk), or the like in a file in an installable format or an executable format to be provided.

The program executed by the POS terminal 1 of an embodiment may be stored in a computer connected to a network such as the Internet and provided by being downloaded via the network. The program executed by the POS terminal 1 of an embodiment may be provided or distributed via the network such as the Internet.

Further, the program executed in the POS terminal 1 of an embodiment may be previously incorporated in a ROM to be provided.

What is claimed is:

1. An information processing apparatus comprising:
a code reader;
a memory; and
a processor configured to:
control the code reader to read a code attached to a package;
determine whether the read code indicates a predetermined code assigned to a package containing a plurality of commodities; and
when the read code indicates the predetermined code,
retrieve from the memory information about the package indicating a total number of the commodities contained in the package,
retrieve from the memory information about each of the commodities indicating a unit price of each of the commodities, and
calculate sales based on the total number of the commodities and the unit price of each of the commodities.

2. The information processing apparatus according to claim 1, further comprising:
a printer configured to print a receipt, wherein
the processor is configured to control the printer to print the receipt based on the total number of the commodities and the unit price of each of the commodities.

3. The information processing apparatus according to claim 2, wherein
the processor is configured to control the printer to print a first total representing a total number of packages each including the commodities and a second total representing a total number of the commodities purchased by a customer.

4. The information processing apparatus according to claim 1, wherein
the information about the package indicates a first number of first commodities and a second number of second commodities different from the first commodities, and
the information about each of the commodities indicates a first unit price of each of the first commodities and a second unit price of each of the second commodities.

5. The information processing apparatus according to claim 4, wherein
the processor is configured to calculate the sales based on the first and the second number and the first and the second unit price.

6. The information processing apparatus according to claim 1,
the processor is configured to:
retrieve from the memory information about a discount applied to one or more commodities contained in the package; and
calculate the sales further based on the information about discounts.

7. The information processing apparatus according to claim 6, wherein
the discount is applied when a predetermined number of same commodities are purchased, and
the processor is configured to:
determine whether the discount is applied based on the total number of the commodities; and
when the discount is applied, calculate the sales further based on the information about the discount.

8. The information processing apparatus according to claim 6, wherein
the discount is applied for a predetermined commodity, and
the processor is configured to:
determine whether the discount is applied to the commodities contained in the package; and
when the package contains the predetermined commodities, the processor is configured to calculate the sales based on the information about the discount

9. The information processing apparatus according to claim 1, wherein
the processor is configured to store information about the sales onto the memory.

10. The information processing apparatus according to claim 9, wherein
the information about the sales includes at least a total number and gross sales of commodities.

11. A method carried out by an information processing apparatus having a code reader and a memory, the method comprising:
determining whether a code read by the code reader indicates a predetermined code assigned to a package containing a plurality of commodities; and
when the read code indicates the predetermined code,
retrieving from the memory information about the package indicating a total number of the commodities contained in the package,
retrieving from the memory information about each of the commodities indicating a unit price of each of the commodities, and
calculating sales based on the total number of the commodities and the unit price of each of the commodities.

12. The method according to claim 11, further comprising
printing a receipt based on the total number of the commodities and the unit price of each of the commodities.

13. The method according to claim 12, wherein
the receipt indicates both a total number of packages each including the commodities and a total number of the commodities purchased by a customer.

14. The method according to claim 11, wherein
the information about the package indicates a first number of first commodities and a second number of second commodities different from the first commodities, and
the information about each of the commodities indicates a first unit price of each of the first commodities and a second unit price of each of the second commodities.

15. The method according to claim 14, wherein
the sales are calculated based on the first and the second number and the first and the second unit price.

16. The method according to claim 11, further comprising:
retrieving from the memory information about a discount applied to one or more commodities contained in the package; and
calculating the sales further based on the information about discounts.

17. The method according to claim 16, wherein
the discount is applied when a predetermined number of same commodities are purchased, and
the method further comprises:
determining whether the discount is applied based on the total number of the commodities; and
when the discount is applied, calculating the sales further based on the information about the discount.

18. The method according to claim 16, wherein
the discount is applied for a predetermined commodity, and
when the package contains the predetermined commodities, the sales is calculated based on the information about the discount

19. The method according to claim 11, further comprising
storing information about the sales onto the memory.

20. A non-transitory computer readable medium storing a program causing a computer to execute a calculation process comprising the steps of:
determining whether a code read by a code reader indicates a predetermined code assigned to a package containing a plurality of commodities; and
when the read code indicates the predetermined code,
retrieving from a memory information about the package indicating a total number of the commodities contained in the package,
retrieving from the memory information about each of the commodities indicating a unit price of each of the commodities, and
calculating sales based on the total number of the commodities and the unit price of each of the commodities.
